(19) United States
(12) Patent Application Publication
(10) Pub. No.: US 2011/0173134 A1
(43) Pub. Date: Jul. 14, 2011

(54) Trade Generation System and Method Thereof

(76) Inventor: Jeremy Mabbitt, East Sussex (GB)

(21) Appl. No.: 13/004,240

(22) Filed: Jan. 11, 2011

Related U.S. Application Data
(60) Provisional application No. 61/294,289, filed on Jan. 12, 2010.

(51) Int. Cl. G06Q 40/00

(52) U.S. Cl. 705/36 R; 705/37

(57) ABSTRACT

A system and method for trade generation to achieve investment objectives is provided. The system may include a first user having a portfolio and at least one investment objective. A computer-implemented device has a database, wherein the database receiving the at least one investment objective and at least one view. An aggregation system is in communication with the database, wherein the aggregation system aggregates a consensus based on the at least one view. A scoring system is in communication with the database, wherein the scoring system calculates at least one score from the at least one investment objective and the consensus. An investment suggestion generator is positioned to output at least one investment suggestion based on the at least one score.

### CROSS REFERENCE TO RELATED APPLICATION

This application claims benefit of U.S. Provisional Application Ser. No. 61/294,289 filed Jan. 12, 2010, the entire disclosure of which is incorporated herein by reference.

### FIELD OF THE DISCLOSURE

The present disclosure is generally related to trade generation and more particularly is related to a trade generation system and method.

### BACKGROUND OF THE DISCLOSURE

Managing and advising on investments and portfolios of investments held by individuals is an important aspect of the economy and society. Generally, investment managers manage, in a professional capacity, a variety of securities with the aim of meeting specified investment objectives for an investor. Investors may include a variety of entities, most commonly institutions or private investors. Maximizing the investment objectives of these investors is a complex process of matching the objectives with the trends of the market. Understanding the relationship between the objectives and market trends has commonly been an inaccurate and cumbersome process that frequently results in a failure to meet an investor's objectives, or a less than desirable resulting investment return.

In the case of financial advisors serving private investors, often their recommendations exhibit biases caused by the differing rates of commission they receive in return for recommending certain investment products. Even where this bias doesn't exist and the advice being offered is truly impartial (usually requiring the investor to pay substantial advisory fees for the service) it can be hard for investors to know whether the recommendations they are being offered really are the best available given their own particular views and requirements.

This lack of transparency is increasingly widely recognized. In recent years millions of private investors have opened accounts with execution-only brokerages, which now make it easy and cost-effective to trade online or by telephone. These investors have done so with the specific intention of taking control of some or all of their investments.

However, most of the these users still trade infrequently and only manage a small portion of their total portfolios themselves via these services. One element that holds them back is not that they have not sufficient developed opinions on investments—after all, most investors will have views on at least one or two stocks, and perhaps on interest rates and exchanges rates, and know people who are happy to offer their own opinions (which they may or may not trust). They also are not limited with access to information, as they are routinely being bombarded with news, commentary, data feeds, graphs and so on, whenever they switch on the television or access the internet. What limits their development of opinion is finding the time to assimilate all of this and translate it into specific trade decisions in which they can feel confident.

Existing tools that touch on addressing this problem generally fall into two camps:

1) Mathematical tools based, directly or indirectly, on the “modern portfolio theory” first introduced by Harry Markowitz in the 1950s. For most users without training in financial engineering these tools are somewhat opaque. Furthermore they are known to produce biased results based on unrealistic (and often dangerous) assumptions and have been discredited in recent years in the view of many financial professionals.

2) Online tools and specialist discussion boards which allow users to communicate and share their views with others. While these are certainly useful services for many private investors, they tend to add to the volume of information that presents itself rather than cutting through it; investors are left to their own devices when it comes to working out exactly what trades to make and when.

Thus, a heretofore unaddressed need exists in the industry to address the aforementioned deficiencies and inadequacies.

### SUMMARY OF THE DISCLOSURE

Embodiments of the present disclosure provide a system and method for trade generation to achieve investment objectives. Briefly described, in architecture, one embodiment of the system, among others, can be implemented as follows. The system contains a first user having a portfolio and at least one investment objective. A computer-implemented device having a database receives the at least one investment objective and at least one view. An aggregation system is in communication with the database, wherein the aggregation system aggregates a consensus based on the at least one view. A scoring system is in communication with the database, wherein the scoring system calculates at least one score from the at least one investment objective and the consensus. An investment suggestion generator is positioned to output at least one investment suggestion based on the at least one score.

The present disclosure can also be viewed as providing methods of trade generation to achieve investment objectives. En this regard, one embodiment of such a method, among others, can be broadly summarized by the following steps: providing at least one investor entity having an investment portfolio; determining at least one investment objective of the at least one investor entity; receiving the at least one investment objective and at least one view at a computer-implemented device having a database; aggregating a consensus based on the at least one view; calculating at least one score from the at least one investment objective and the consensus; and generating at least one investment suggestion based on the at least one score.

The present disclosure can also be viewed as providing methods of providing a consensus to a plurality of investors. In this regard, one embodiment of such a method, among others, can be broadly summarized by the following steps: providing a plurality of investor entities; capturing a plurality of views from at least a portion of the plurality of investor entities; aggregating the plurality of views to determine a consensus; and providing the consensus to at least a portion of the investor entities.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can he better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram illustrating a system of trade generation to achieve investment objectives, in accordance with a first exemplary embodiment of the present disclosure.

FIG. 2 is a schematic diagram illustrating a system of trade generation to achieve investment objectives, in accordance with a second exemplary embodiment of the present disclosure.

FIG. 3 is a schematic diagram illustrating a system of trade generation to achieve investment objectives, in accordance with the second exemplary embodiment of the present disclosure.

FIG. 4 is a schematic diagram illustrating a system of trade generation to achieve investment objectives, in accordance with the second exemplary embodiment of the present disclosure.

FIG. 5 is a schematic diagram illustrating a system of trade generation to achieve investment objectives, in accordance with the second exemplary embodiment of the present disclosure.

FIG. 6 is a flowchart illustrating a method of trade generation to achieve investment objectives, in accordance with a third first exemplary embodiment of the present disclosure.

FIG. 7A is a flowchart illustrating a method of trade generation to achieve investment objectives, in accordance with the third exemplary embodiment of the present disclosure.

FIG. 7B is a flowchart illustrating a method of trade generation to achieve investment objectives, in accordance with the third exemplary embodiment of the present disclosure.

FIG. 8 is a flowchart illustrating a method providing a consensus to a plurality of investors, in accordance with a fourth first exemplary embodiment of the present disclosure.

### DETAILED DESCRIPTION

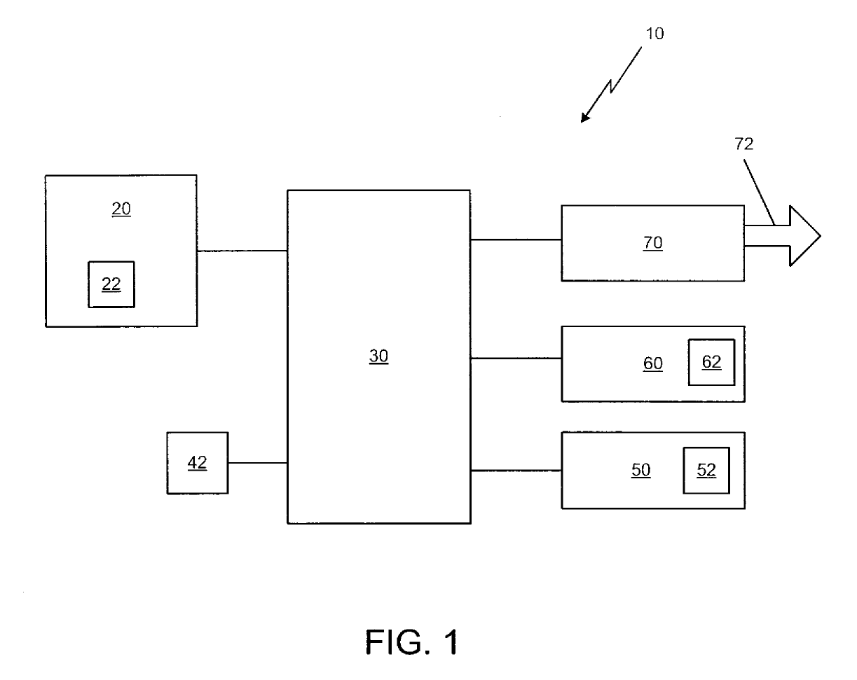

FIG. 1 is a schematic diagram illustrating a system 10 of trade generation to achieve investment objectives, in accordance with a first exemplary embodiment of the present disclosure. The system 10 includes a first user 20 having a portfolio and at least one investment objective 22. A computer-implemented device has a database 30, which may receive at least one view 42. An aggregation system 60 is in communication with the database 30 and may aggregate a consensus 62 based on the at least one view 42. A scoring system 50 is in communication with the database 30 and may calculate a score 52 from at least one of the at least one investment objective 22 and the consensus 62. An investment suggestion generator 70 is positioned to output at least one investment suggestion 72.

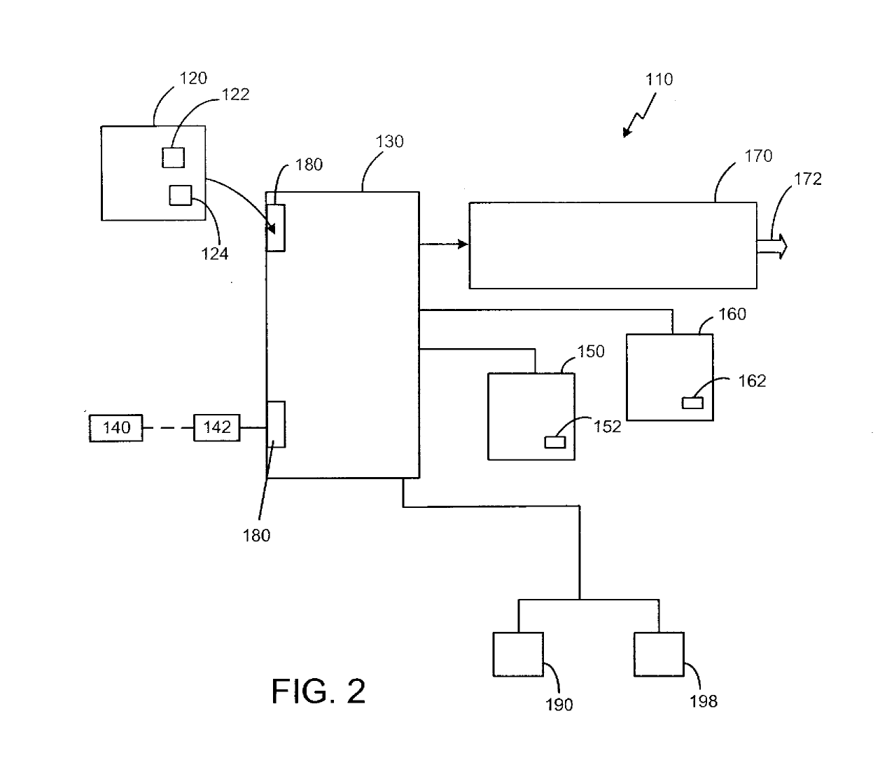

FIG. 2 is a schematic diagram illustrating a system 110 of trade generation to achieve investment objectives, in accordance with a second exemplary embodiment of the present disclosure. The system 110 for trade generation to achieve investment objectives includes a first user 120 having a portfolio and at least one investment objective 122. A computer-implemented device has a database 130. The database 130 may receive the investment objective 122 and at least one view 142. An aggregation system 160 is in communication with the database 130 and may aggregate a consensus 162 from the at least one view 142. A scoring system 150 is in communication with the database 130 and may calculate a score 152 from the at least one investment objective 122 and the at least one consensus 162. An investment suggestion generator 170 is positioned to output at least one investment suggestion 172 based on the at least one score 152.

The first user 120 of the system 110 may include any investor with a portfolio 124 and at least one investment objective 122. For example, the first user 120 may be any person, group of people or entity having and/or making an investment. Commonly, the first user 120 may have a purpose for having or making the investment, such as seeking to grow, expand or alter his or her portfolio 124 of investments, to raise money, expand wealth or otherwise benefit from the investment. For instance, the at least one investment objective 122 may be specified in terms of a desired characteristic of future portfolio 124 value or cash flow, as may be determined by the system 110. The portfolio 124 of the first user 120 may include any type of portfolio 124, explicit or implicit, structured or unstructured. For example, the portfolio 124 may include an established grouping of stocks that have an established market value and have been subject to market changes for a period of time. Alternatively, the portfolio 124 may simply include a quantity of uninvested investment money that the first user 120 intends to invest. Any quantity of investable assets in any format that could be used to achieve the investment objective 122 may be considered the portfolio 124 of the first user 120. The investable assets may include, for example, stocks, funds, options, derivatives, spread bets, commodities or real estate holdings.

The at least one investment objective 122 may include any number of investment objectives 122, which may be linked, independent or a combination thereof. Commonly, some investment objectives 122, which may be considered standard for the system 110, include upside profit and loss (P&L), the mean portfolio value for the top third of portfolio paths, mid P&L, the mean portfolio value for the mid third of portfolio paths, and downside P&L, the mean portfolio value for the bottom third of portfolio paths, in each case at a fixed point in time. When the first user 120 has a given set of potential trades, the three standard investment objectives 122 may be measured according to their proportional change relative to the current portfolio 124, thereby normalizing them with respect to absolute portfolio value. Accordingly, a 5% improvement in upside P&L may be considered equivalent to a 5% improvement in downside P&L. From these measurements, the first user 120 can apply a relative weighting to each of the three investment objectives 122 according to his of her preference for upside potential vs. downside risk. Frequently, these standard investment objectives 122 are weighted or otherwise configured, such as by calculating a weighted sum of the investment objectives 122. An aggregate score for the portfolio 124 may be calculated by taking the weighted sum of the three or more normalized objective scores 152.

In one of many alternatives, the investment objectives 122 may include a future liquidation value of the portfolio 124, which may take into account any costs associated with exiting positions, and risk measures such as value-at-risk. In some cases, a first user 120 may use a simple default objective for an investment objective 122. This may include an investment objective 122 of maximizing an expected return, or any other simplified investing goal. Additionally, the system 110 may also maximize a single objective subject to at least one limit specified by the first user 120. For example, the system 110 may maximize the first user's 120 expected portfolio value based on specific or general limits, i.e., levels of risk that is specified by the first user 120. Accordingly, as an example, the system 110 may seek to maximize expected return of the portfolio 124 in 12 months, 6 months, etc., all while ensuring that the likelihood of the portfolio 124 losing more than 50% in value is kept below 5%. This may allow the system 110 to efficiently handle the at least one investment objective 122 in accordance with specific requests by the first user 120.

The first user 120 may input the at least one investment objective 122 into the database 130 along with first user's 120 portfolio 124. To ensure that an investment objective 122 is met, the first user 120 may also input additional information into the database 130, such as investment constraints and preferences including desired sector exposures, number of holdings, holding size, holding characteristics and information that might relate to tax calculations, for example. The database 130 may include a variety of databases such as a computer hard drive, portable computerized memory or other computer-implemented device capable of storing information. The database 130 may be in communication with a computer readable medium, such as a personal computer or a computerized network. Commonly, the database 130 will be hosted on or integral with a computerized network and in communication with other computerized networks, such as on a server accessible by the first user 120 through an Internet connection. In accordance with this disclosure, the database 130 may include any computerized or electronic database capable of receiving and storing computerized or electronic information, and hosted on any type of computerized or electronic device, including personal computers, servers, PDAs, laptops and networks of computers. Naturally, any of the computerized or electronic devices may include any number of processors capable of running a variety of computerized programs.

To facilitate inputting the at least one investment objective 122 and/or the first user's 120 portfolio 124, or any other information into the database 130, the system 110 may include an interface, such as a website, facilitating interaction by the first user 120, or any additional user. The interface may include any standard features commonly used with computerized interfaces, including log-in and log-out elements with user-specific identifications and passwords, security features, encryption elements, data blocks presenting information to the first user 120, searching elements, user assistance features, and/or data transmission elements. Any other feature that is used with a computerized interface may also be included within the system 110, and is considered within the scope of the present disclosure.

The database 130 is also situated to receive and store at least one view 142. The at least one view 142 may include any number of views 142 from any number or type of users. The view 142 may be characterized as any fact, opinion, belief or judgment that might be relevant to the first user's 120 investment decisions. The view 142 may be a belief or judgment associated with a financial market, or an instrument, company, underlying factor, action or decision associated directly or indirectly with that financial market. The view 142 may be based on opinion or factual experience, or any combination thereof. For example, a view 142 may be an opinion about a price target for a particular stock, or an exchange rate between two currencies, or an underlying factor such as consumer confidence or a particular country's GDP. The view 142 may be specific to a particular investment or applicable market-wide. The view 142 may further include a variety of specific opinions or groupings of opinions. For example, as discussed herein, the aggregation system 160 aggregates a consensus 162 based on the views 142 within the system 110. Accordingly, the consensus 162 may be a collective understanding of a plurality of views 142 that come from one or more users.

Other type of views 142 may include views 142 of the first user 120, views 142 of a second user 140, as is shown in FIG. 2, which may be the view 142 of a professional investment research entity, broker or any other entity. The view 142 may also be a grouping of views 142 associated with a particular train of thought, for example organized into scenarios, where a set of views 142 are expressed on a particular subject each with a given level of confidence. In this case the same defined scenarios and confidence levels might apply across more than one view subject. For example, a 30% likelihood ‘recession scenario’ could apply to various stocks which the user has views 142 on, with the user's opinion as to the likely impact of that scenario being different in each case. As can be seen, may different types of views 142 may be used within the system 110, all of which are considered within the scope of the present disclosure.

In some instances, the view 142 may be derived from at least one second user 140, as is indicated in FIG. 2. The second user 140 may include any type of user, including an investor, an investment broker or individual/grouped investment entity, and may commonly be able to offer information regarding a particular investment, an industry or strategy. For example, the second user 140 may be an investor with a particular knowledge or information about investments or portfolios in general, and/or a specific aspect of investments, such as a particular industry. The second user 140 may also be a stock broker, a company engaged in the practice of giving investment research, and/or a computerized device capable of creating or communicating at least one view 142 based on a quantity of data. The view 142, or any portion thereof, may be compiled within the database 130 for use at a later time by the aggregation system 160, or another component of the system 110. The view 142 may be transferred, adopted or taken by any user of the system 110. For example, a view 142 provided by a second user 140 may be adopted as a view 142 by the first user 120. Alternatively, the view 142 of the second user 140 may influence a view 142 of the first user 120, whether in a positive way or in a negative way, whereby the first user 120 may opt to ignore the second user's 140 view 142.

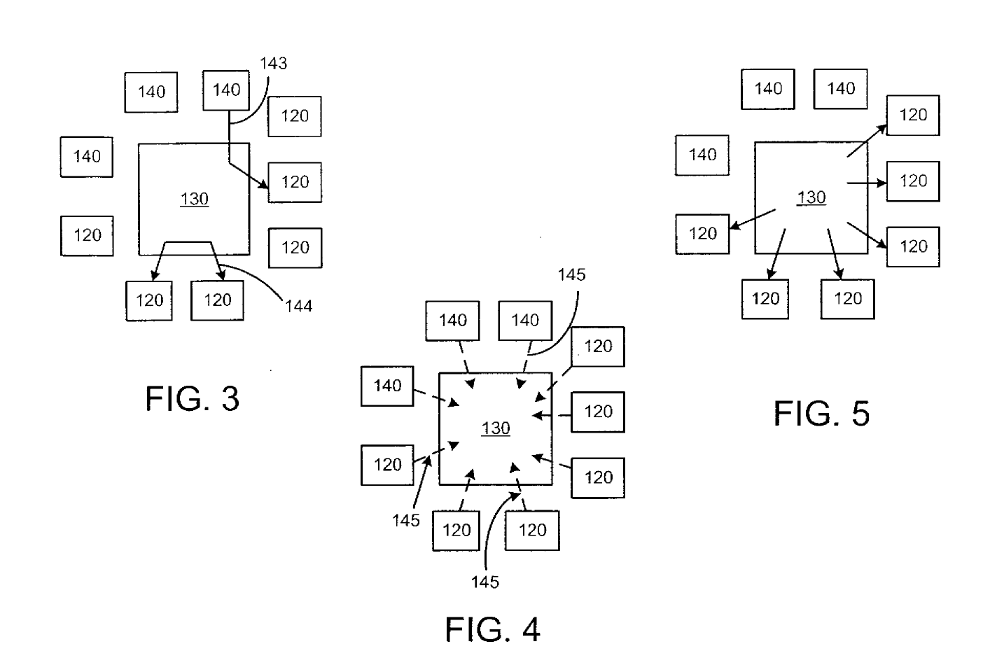

The aggregation system 160 may be in communication with the database 130 in any configuration, which may include an integral or wired communication. The aggregation system 160 aggregates the consensus 162 from the at least one view 142. Aggregation may be accomplished in a variety of ways, as is described in more detail with respect to FIGS. 3-5. For example, aggregation may be achieved from simple numerical average aggregations to aggregations accounting for any combination of weighted views 142. Weighed views 142 may be based on various factors, including historical records, calculations of future success likelihood, or any other factors. Ultimately, the consensus 162 may provide the general or predominate opinion within the at least one view 142.

The scoring system 150 is in communication with the database 130, and may calculate a score 152 based on the at least one investment objective 122 and consensus 162. The score 152 may be produced in any format, such as via a textual output, a numerical output, a binary output, a computer code formation, such as a computer program, or any other format, as may be determined by the system 110 and/or the first user 120. The score 152 may also be weighted, configured or otherwise adjusted. For example, the scoring system 150 may calculate the score 152 by evaluating the first user's 120 portfolio 124 with the first user's 120 investment objective 122.

The scoring system 150 may also make input assumptions for the first user 120 to create an assumed view. This may be done in a way that captures the most natural way for the first user 120, i.e., in a way that does not substantially deviate from a natural view that the first user 120 may have. For example, in a simple case, the user's views might include an opinion, for each of any number of particular stocks, of where the user thinks the stock price might move to in a given period of time and with a specific level of confidence. The scoring system 150 may create assumptions that determine what could happen to any given portfolio 124 of the first user 120 given this information. This may require more information than the first user 120 has provided, for example the risk or volatility associated with each stock, correlations between stocks and/or what might happen to stocks the first user 120 hasn't expressed views on. The scoring system 150 may infer assumptions from any views 142 of other users, such as the consensus, which may provide information on what might happen to stocks the first user 120 doesn't explicitly have a view on.

The consensus may also provide information about the risk associated with any additional stocks. For example, if any users of the system 110 have widely varying views on where a particular company's stock price is heading, the assumption might be that it is a risky investment. The consensus can also provide information about dependencies between stocks, e.g. if a high proportion of users have said they think company A's stock and company B's stock are heading in the same direction. This is all useful information that the system 110 attempts to capture. Once captured, the data may be modeled on a modeling system, such as the ‘Monte Carlo’ modeling discussed further herein. The ‘Monte Carlo’ model may be a powerful tool, since it is flexible and easy to capture various aspects of the consensus 162 and other views. Another model capable of being used is the prevalent correlation-based model used in ‘Modern Portfolio Theory’, which takes as input a vector of expected returns for each asset and a matrix of correlations between each pair of assets. However, this may considerably less flexible and realistic than the ‘Monte Carlo’ approach. More generally, the model may be any computational framework or algorithm that is able to adequately and quickly capture the available information including the first user's 120 views 142 and produce a forecast for a given portfolio 124 that is as realistic as possible in the eyes of that user.

It is noted that sometimes a users' views alone are insufficient to provide all the information needed to run a model. If this happens, the system 110 may make statistical inferences from historic data. For example the system 110 may look at historic volatility as a guide to future stock volatility in the absence of sufficient information in users' views 142. The system 110 may account for any other gaps in the consensus 162, as may be recognized by the system 110, by using historical market data and making inferences from it. Any gaps that the scoring system 150 fills in may be communicated to, or visible to the first user 120, such that the first user 120 is aware of any assumptions that the scoring system 150 is making. Accordingly, the first user 120 may correct, alter or delete any assumptions made by the scoring system 150.

To calculate the score 152, the scoring system 150 may use a variety of techniques, as will be discussed in detail herein. One technique may be commonly referred to in the industry as a ‘Monte-Carlo’ simulation, where future movements in variables, such as stock values, share prices, dividends, interest rates, etc., may be simulated across the first user's 120 investment universe. With this technique one or more views 142 and/or the consensus 162 can be utilized to randomly, or pseudo or quasi randomly, generate one or more potential paths through a given period of time. For any given portfolio 124 of the first user 120, the various paths for any number of individual instruments may be aggregated to calculate one or more paths for the portfolio 124 as a whole. By repeating this process many times, in each case with different random inputs or seeds, a time series of probability distributions can be built up describing how the portfolio's value might vary with time.

In accordance with this disclosure an instrument may be characterized as any investment product such as a stock. Accordingly, the instrument could be a fund holding, which may be modeled as a collection of individual instruments, assuming that knowledge of the fund's holdings is available, or effectively as an instrument itself if knowledge of the fund's holdings is not available. In the latter case, the instrument may be characterized in terms of industry exposures, or other factors. Other simulating techniques may include analytical closed-form simulations or neural networks. Some of these techniques may be designed to yield repeatable results more quickly than exhaustive simulation processes, such as the ‘Monte-Carlo’ technique, but they may be less flexible than the exhaustive simulation processes.

An important aspect of the system 110 that is addressed by the scoring system 150 concerns the inherent nature of making a simulation. As with any investment, an investor may have points of certainty and points of uncertainty with various aspects of the investment. For example, the first user 120 may have specific objectives with clear or certain views 142, but may also be uncertain about an investment objective 122, or a view 142 in general. For example, the first user 120 may have a view 142 of simply maximizing expected return. The scoring system 150 not only takes into account the first user's 120 certainty, but also captures and accounts for the first user's 120 uncertainty, which allows the scoring system 150 to calculate an accurate score 152 with a realistic level of precision, avoiding ‘over-analyzing’ the user's views. The scoring system 150 calculates the score 152 with sufficient transparency to the first user 120, whereby it is possible for the first user 120 to see for him or herself how the score 152, i.e., future probability distributions, are calculated. Doing this in a way that places an emphasis on a realistic understanding of the score 152, and not on an abundance of spurious precision within a score 152, e.g., a value at risk (VaR) score calculated to three decimal places, provides the first user 120 with an accurate understanding how to accomplish a particular investment objective 122, or how to make investment decisions. However, it is noted that in accordance with this disclosure, the score 152 may include information in a variety of formats, including a numerical format with decimal places, or any other detailed format.

As an example, the scoring system 150 may calculate a score 152 from the investment objective 122 of the first user 120 based on their view(s) 142 of individual stock prices. In this case, the first user 120 may first specify a view 142 or a plurality of views 142 on any individual stock price. Alternatively, the consensus 162 may be used in combination with or in place of a view 142 of the first user 120. Each view 142 may consist of a set of one or more ‘scenarios’, each having a specified probability that adds up to a total probability sum, i.e., a total that adds up to no more than one. Furthermore, each of the views 142 may be assigned a confidence rating, such as ‘low’, ‘medium’ or ‘high’, or any combination thereof. Each scenario may include a series of one or more future price targets, each of which may include a price level and a date and time. Prior to the first user 120 having any specific views 142, the scoring system 150 may automatically generate a single 100% probability scenario with a price target and confidence level extrapolated from historic price movements of stock. When a likelihood of each scenario is obtained, perhaps by the first user 120 or another entity, the scoring system 150 may then simulate a variety of price paths for the stock according to an independent normally-distributed random walk with price targets interpreted as a corresponding rate of drift and confidence level as interpreted as a corresponding variance. Many paths may be generated for each scenario, with the number of paths being proportional to the specified likelihood of each scenario. From the paths generated, an aggregate price distribution for the stock may be calculated, and in general, the aggregate price distribution may be non-normal. Accordingly, based on this simplistic example, it may be possible to perform the calculation more efficiently using mathematical shortcuts that avoid the need to generate random price walks, as they are computationally expensive. However, in other situations, it may not be feasible to use shortcuts, as the complexity of the simulation requires more analysis.

Complex score 152 calculations may occur with views 142 that are beyond individual stock prices. This may require more realistic models which may be used to model, for example: non-normal or asymmetric price distributions for each scenario; volatility clustering; scenarios linked across multiple instruments, for example sector, country or market-wide scenarios; relative views, for example that Company A stock will outperform the S&P 500 by a given amount; future dividend payments, and a first user's 120 view on these; and other kinds of dependencies between instruments, sectors, and market factors, such as correlation and cointegration. This approach may also extend to other types of instruments, such as, for example: bonds, where the first user 120 specifies views on interest rates and default probabilities; FX derivatives, where the first user 120 specifies views on various exchange rates; equity options, where the first user 120 might specify views on volatility; and mutual funds, wherein the first user 120 may specify views on the fund relative to a given index.

Simulation of the variety of price paths may be carried out in accordance with a predetermined process, a manual process, or any combination thereof. For example, simulation may be re-run at either the first user's 120 request and/or at a time scheduled by the scoring system 150, or at another specified time. This may depend on what parameters, i.e., market prices, views, etc., have changed and on the database 130 loading, which may include loading of a server central processing unit (CPU) associated with the database 130. Simulations may be run for an individual portfolio 124, where each instrument in the portfolio 124 is simulated. An aggregated picture or simulation of the overall portfolio 124 may then be created based on the simulations of the individual instruments. A simulation may also be run for a given set of potential trades and a specified portfolio 124. In this case, it may be equivalent to simulating a modified portfolio 124, with the addition of transaction costs to the output. To avoid repetition of calculations and enhance performance of the scoring system 150, simulations for individual instruments may be cached ahead of a search, wherein thousands of sets of potential trades might be evaluated. It may be the case that the simulation is run across the first user's 120 entire investment universe, i.e., all investments that the first user 120 is prepared to consider, in advance of the search process.

FIGS. 3-5 are schematic diagrams illustrating a system of trade generation to achieve investment objectives, in accordance with the second exemplary embodiment of the present disclosure. As discussed above with regards to FIG. 2, the first user 120 may choose to follow a view 142 of a second user 140, which may be arranged in a variety of ways. As specified previously, the second user 140 may have expertise in investing and may be qualified to provide a view 142, such as an individual stock broker, a team of researchers at an investment company, or any other entity. For example, a second user 140 may also be an investor using the system 110 that provides a view 142. Any number of views 142 may be provided to the first user 120 by uploading them to the database 130 via an input element 180. This may include uploading the views 142 to the database 130 where the input element 180 is an Internet connection capable of transmitting data. Any second user 140 may make their views 142 available to, or viewable by any first user 120, or selected First users 120. For example, a particular investment firm may chose to make their views 142 available to only first users 120 who are their customers.

Additionally, a first user 120 may choose to follow a particular view 142 of a second user 140, or any number of views 142 of the second user 140. For example, a first user 120 may choose to follow the views 142 of a second user 140 only with regards to a particular industry sector, e.g., healthcare, or across all industry sectors that the second user 140 has a view 142 in. If the first user 120 opts to follow all of the views 142 of the second user 140, the first user's 120 view 142 may effectively become the same as that of the second user 140 being followed. Alternatively, the first user 120 always has the option to choose to inspect the view 142 of the second user 140, and subsequently use the inspected view 142 to create their own, differing views.

As can be understood from this disclosure, an operative aspect of the system 110 is the ability to exchange views 142 between users, namely from the second users 140 to the first users 120. As is illustrated in FIG. 3, a plurality of first users 120 may be able to obtain views 142 through the databases 130 from a number of sources, including one or a plurality of second users 140 and other first users 120. The first users 120 may choose to follow the views 142 of any of the second users 140, as indicated by arrow 143, or first users 120 may pool efforts with other first users 120 to gain information about a view 142, as indicated by arrow 144. One way to facilitate this exchange of views 142 is through the creation of networks of users. The users, whether first users 120, second users 140 or any additional parties, may create these networks within the system 110 to share information about views 142. The networks may be designed or configured in a variety of ways, include being public, private and/or semi-public or semi-private. For example, a first user 120 may create a network of other users whom the first user 120 meets through the system 110. This network may include new acquaintances, but it may also include people the first user 120 already knows (i.e., their own stock broker), or people they have had correspondences via other means.

The networks may also be created by the system 110 for users, and may be tailored to particular views 142, theories or ideas about investing. Regardless of how the network is formed, the users that are a part of it may share various ideas and views 142 with other users in the network. For example, a first user 120 or second user 140 may share his or her statistics on the performance of their respective investments across different industry sectors. The users within the network can choose what to share and what to keep private, but ultimately enough users may share enough views 142 to create a pool of various views 142 that allow the first user 120 to make better investment decisions than he or she would without the pool of views 142. Furthermore, the system 110 may allow not only for the sharing of views 142 between users, but also the buying and selling of views 142 in a marketplace for investment research. Accordingly, the system 110 may allow users to monitor independently the accuracy of other users' research and allow users to build up track records based on past performance. This, in turn, may build up value in their views 142. In other words, the system 110 may host a system for rating a user's views 142, wherein certain users' views 142 may become valued more than other users' views 142.

As an example of the how users can share views 142 using the system 110, consider a situation where two users, user A and user B are investors interested in gaining information or views 142 for a particular investment objective 122. Users A and B may both be a first user 120, one may be a second user 140, or any other third-party user. User A may have worked in the pharmaceuticals industry for 30 years and therefore may have an informed opinion on pharmaceuticals stock. User B may have a particular insight into emerging markets financial stocks. As both user A and B may wish to maintain well-diversified portfolios 124, while maximizing their exposure to new investment opportunities, they may elect to trade or exchange their views 142 in each area. User A may follow User B in relation to emerging markets financials, while User B may follow User A on the pharmaceuticals industry. This exchange of views 142 between users may allow the system 110 to generate informed investment suggestions for each user across a wide investment universe, tailored to their differing appetites for upside potential vs. downside protection, their unique portfolio 124 exposures and their particular tax situations.

With reference to FIGS. 2-5, the aggregation system 160 may aggregate a consensus 162 based on investment objective 122 and the at least one view 142. The aggregation system 160 may include a variety of computerized and/or electronic components or computer readable code having instructions carrier out by a processor. As is illustrated in FIG. 4, the aggregation system 160 may combine the views 142 of each user, i.e., first users 120 and second users 140, to create the consensus 162 on each instrument. Arrows 145 in FIG. 4 illustrate the process of combining and aggregating each user's views 142. As is illustrated in FIG. 5, the aggregation system 160 may then publish this information to all users within the system 110, or within a particular network, as may depend on the system 110 design.

The aggregation system 160 may be capable of aggregating the consensus 162 in a number of ways. For example, for a stock price, the aggregation system 160 may calculate the mean forecast distribution of the stock's price over all users expressing a view 142 on that stock. In addition, the aggregation system 160 may weight a user's view 142 according to the degree of confidence that the specific user appears to have in that view 142, determined according to their actions rather than just their ‘professed’ level of confidence in their view. A determination of the degree of confidence that a user may have in his or her view and its corresponding weighting can be inferred by looking at the extent to which the view 142 has been leveraged in investment decisions. If a user's actual investment decisions are known and can be verified, for example by synchronizing their portfolio with their broker, then the weighting can be made stronger. The aggregation system 160 may also weight views 142 of users according to the forecasting track record of the user, the number of followers they have, or other information relating to the user's credibility, either overall or in relation to the specific view in question. Any user may elect to follow any consensus 162, and may use this view as the basis for generation of trading ideas to achieve an investment objective 122, or to influence, inform or otherwise effect their view 142 on the market or their investment objective 122.

Again referring to FIG. 2, the system 110 may include an investment suggestion generator 170, which may include a variety of computerized and electronic components. For example, the investment suggestion generator 170 may include computer readable code having instructions carried out by a processor, which communicates with an output device to output at least one investment suggestion 172 from the score 152. Within the industry, the investment suggestion generator 170 may be characterized as an intelligent search engine that generates one or more sets of trades for the users of the system 110, and maximizes the scores 152 calculated within the scoring system 150 against a first user's 120 investment objective 122. The investment suggestion generated may be a set of one or more specific trade ideas provided to the first user 120 for the purpose of achieving an investment objective 122. The investment suggestion may include any number of individual or grouped suggestions for making any number of trades, and achieving any number of investment objectives 122. To accomplish this, the investment suggestion generator 170 may use a combination of domain-specific heuristics and search-based algorithms, such as evolutionary algorithms. Furthermore, generated trades within the investment suggestion generator 170 may be compared with trades generated using other means, such as those used by other systems, by inputting the plurality of generated trades into the scoring system 150 and calculating objective scores 152.

One technique that the investment suggestion generator 170 may use to calculate trades for users is with one or a plurality of search algorithms. The search algorithms may explore the space of possible trade sets and their scores as determined by the scoring system 150. This may involve performing any number of evaluations with the scoring system 150, perhaps thousands, with different trade sets, using the results of each evaluation to inform subsequent calculations. By embedding domain knowledge into the search process, in particular into the mechanism for generating new trade sets based on previous attempts, it may be possible to make the search process converge on solutions attractive to the users within a reasonable timeframe. One preferred search algorithm is based on the genetic or evolutionary algorithm concept, in which a set or ‘generation’ of candidate solutions is generated randomly and evaluated. Then, the best solutions are selected and operated on to form a new generation, which is evaluated. This iteration process may be used any number of times to generate new trade sets. The investment suggestion generator 170 may maintain a ‘frontier’ of best solutions of the generated trade sets, especially when multiple investment objectives 122 are specified with no trade-off. The user can then choose which of the frontier solutions they like the best for carrying out their investment objective 122.

As may be understood within the industry, heuristics may be used to generate the initial candidate solutions, to give the search algorithms a starting point that is better than merely randomly-generated solutions. Preferably, this may further involve a mini-search process, with the investment objective 122 and/or scoring system being a simplified investment objective 122 and/or scoring system, as opposed to a complex investment objective 122 and/or scoring system. For example, a simplified investment objective 122 may be maximizing the risk-weighted return of the portfolio 124, whereas a complex investment objective 122 may include a plurality of specific investment objectives 122 compiled together. The simplified investment objective 122, i.e. the risk-weighted return, may be easily calculated for each constituent based on its expected return and variance. Another heuristic for stock selection may be ranking the investment universe according to expected return, then picking the highest return stocks in each industry sector, thereby ensuring there is a level of diversification in the portfolio 124. While the result may not produce the best possible portfolio 124, it is likely to be a better starting point than one generated at random.

The system 110 may also facilitate tracking or monitoring of the accuracy of a view 142 and establish a system for valuing a view 142 or the source of the view 142. This may be used with first users 120, second users 140, independent research houses, or private users. The system 110 may have extension points to allow professional investment managers to input previously created models containing their view 142 of the market. This may include such models as portfolio models, risk models, pricing models, forecasting models, or any other model known to those within the industry. Additionally, the system 110 may be able to connect with other entities, such as brokers, to enable the first user's 120 portfolio 124 to be synchronized with a broker account. This may facilitate the execution of trades directly from the system 110.

The system 110 may also include a scoring-based mechanism to generate reasons for a generated investment suggestion. For example, the investment suggestion generator 170 may generate reasons with a rule-based process, which may be performed without the need for after-the-event reason attribution modules. This may be a simple method for generating reasons, and provide the first user 120 with information that is commonly standard within the industry. In one of many alternatives, the scoring-based mechanism may attribute reasons to a result of the search process within the investment suggestion generator 170. This may also be considered ‘reason-attribution’, where the system 110 reverse engineers any qualitative reasons within the investment suggestions 172 based on a quantitative analysis. This may include providing a series of rules, which assign weights to any of the investment suggestions 172, based on reasons, or another classifying attribute. For example, a zero-weighted investment suggestion 172 within a particular reason, e.g., ‘Reason A’ indicates that Reason A does not apply. Non-zero-weighted investment suggestions 172 may have weight calculated relative to a percentage of a total, which may then be presented to the first user 120. For example, if the investment suggestion 172 suggests the first user 120 sell 200 shares of Company A, the scoring-based mechanism may provide three weighted reasons. Reason 1 may be to free up cash to invest in another company, which may be weighted 60%, for example. Reason 2 may be to reduce concentration in banking stocks, and may be weighted 30%. Reasons 3 may be to spread risk of exposure across more industry sectors, and may be weighted 10%. Accordingly, a first user 120 can adequately see that the option of investing in another company, carrying 60% weight, is the primary reason to follow the investment suggestion 172.

In accordance with this disclosure, it is noted that a variety of additional components may be added to or used with the system 110. Likewise, a variety of additional steps may be included to enhance the efficiency or utility of the system, thereby providing a better service to the users. For example, the system 110 may be capable of adhering to a wide range of constraints that are definable by the user. Through a constraint input system 198, the user may be able to express hard limits or constraints on how their investment objective 122 is achieved. For instance, a user may wish to define a hard limit on what they want from a portfolio 124, due to tax reasons. Additionally, the user may be able to set constraints to express their preconceptions as to what their portfolio 124 should include.

As is illustrated in FIG. 2, the system 110 may also include input elements 180 in communication with the computer-implemented database 130. The input element 180 may transmit the at least one investment objective 122 from the first user 120 and the at least one view 142. One or more input elements 180 may be in communication with the computer-implemented database 130 by any communication means available, including a wired communication connection, a wireless communication connection and an integral communication connection. The input clement 180 may include a variety of devices that are commonly used with a computer, including a mouse, a keyboard, a touch-screen, a data-port, a removable input device, a PDA, a cellular telephone, an input device within a network or any other input device known to those having skill within the art. The system 110 may also include a display device 190 for displaying at least one of the at least one view 142, an investment objective 122 of the First user 120, a calculated score 152, the consensus 162 and the investment suggestion 172. The display device 190 may be in communication with any other component of the system 110.

The system 110 may include a number of additional features to best provide quality service to its users. For example, since the search process within the investment suggestion generator 170 involves many repetitive calculations, it lends itself well to being configured to run in a parallel Cashion within a network or grid of interconnected processors, which may include one or a plurality of independent or interconnected computers. When the investment suggestion generator 170 is run on independent processors, it may enhance the speed at which the system 110 can create investment suggestions 172 over a single processor that may become overwhelmed by the number of evaluations that must be performed. Likewise, the scoring system 150 may also be run on a plurality of parallel computers or processors, to enhance the speed of calculating the scores 152. For example, the ‘Monte Carlo’ simulations discussed previously many include a base calculation of the path of each instrument in parallel. If more dependencies are desired or needed to be simulated, more sophisticated algorithms may be used.

There are still further aspects that may be included in the system 110, such as pricing financial instruments. Within the industry, most existing analytical pricing tools for financial products calculate the universal ‘fair value’ of the product in the market at that moment. To calculate this often involves making various mathematical assumptions such as there is no arbitrage in the market. For instance, a derivatives dealer pricing a structured product may calculate its price using such a model, and quote this price, plus any fees, to its customers. Its customers, if they have access to similar pricing analytics, can verify the price for themselves. However, the price they are seeing is the idealized ‘one-size-fits-all’ fair value of the product. What would be far more relevant to the first user 120 is to know at what price the product would represent a worthwhile investment for them, bearing in mind their existing holdings within their portfolio 124, their views 142 on the market, their investment objectives 122, constraints, tax situations, etc.

The system 110 may perform this calculation by introducing such a financial product into the available universe of assets for the intelligent search process to work on. The price of the financial product may be handled by the system 110 as a search variable alongside the standard search variables, principally, the number of contracts of each instrument to buy or sell. At some price threshold, it may almost always make sense for the investor to either buy or sell a quantity of the product, and this price threshold may be determined for the first user 120 by the system 110. The price. that the system 110 may calculate may be tailored to each individual first user 120 and for the same financial product, different first users 120 may receive different prices. As a tool for decision-making, this price may be far more useful than the more usual, idealized fair market value that conventional pricing tools provide.

The system 110 may use over-the-counter (OTC) investment products and search on variables that define those products. For example, the system 110 may be able to determine the price that a structured credit product would make a successful investment for an investor, as well as determine an optimal structure of the product itself with the investor's requirements taken into account. Another feature of the system 110 is the ability to coordinate trades between users having complementary investing positions. The system 110 may be able to identify such positions and determine the existence of an opportunity to make better trades between users. This may be used to provide liquidity to users and reduce trading costs.

Furthermore, the system 110 may facilitate for a plurality of users to make trades directly with one another, such as if the positions of their investment objectives 122 are complementary. The system 110 may be able to identify such opportunities and initiate or propose the transaction, thereby helping to provide liquidity to users and reduce the costs associated with standard trading. The system 110 may also allow some users, most likely second users 140 who are professional investment managers and often have existing financial models, to encapsulate their own quantitative research and view 142 on the market within the system 110. This may include a user's portfolio 124 models, risk models, pricing models, forecasting models, or any other model that the user may have. This may be achieved by providing plug-in or extension points that allow the users to upload, incorporate or otherwise associate their models with the system 110. This may further enhance the system 110 by allowing it to handle custom financial instruments, pricing algorithms, risk measures and/or objectives. To provide the best access and use of the system 110, users may upload their portfolios 124 to the system 110 and synchronize them with an associated broker account. This may allow generated trades to be executed directly from the system 110.

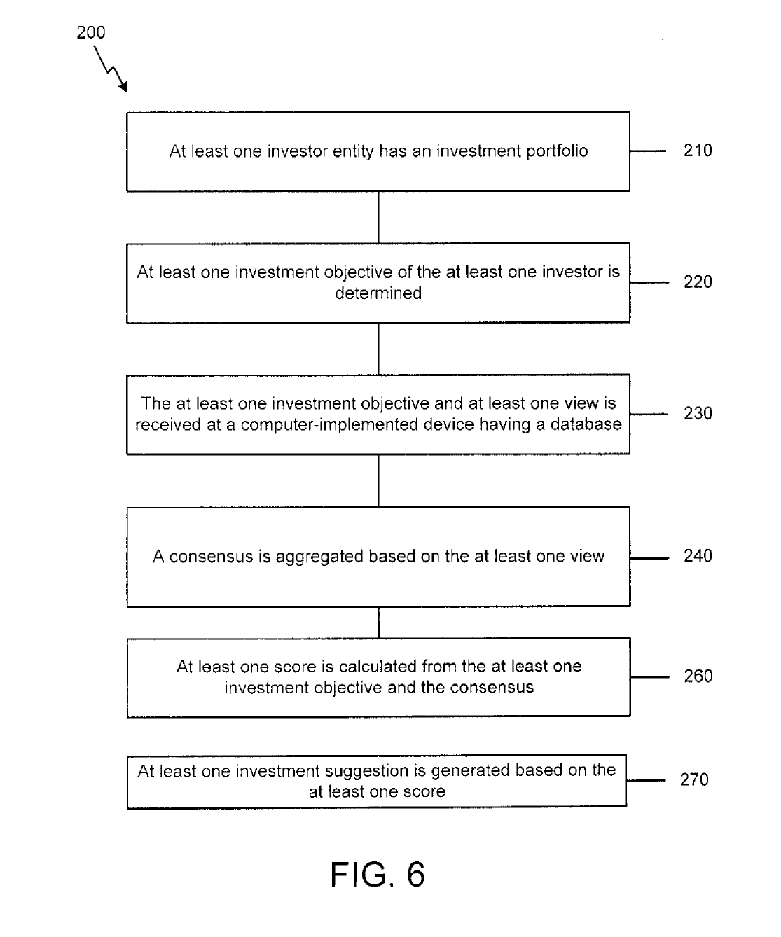

FIG. 6 is a flowchart 200 illustrating a method of trade generation to achieve investment objectives, in accordance with a third exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 210, at least one investor entity has an investment portfolio. At least one investment objective of the at least one investor entity is determined (Block 220). The at least one investment objective and at least one view is received at a computer-implemented device having a database (Block 230). A consensus is aggregated based on the at least one view (Block 240). At least one score is calculated from the at least one investment objective and the consensus (Block 260). At least one investment suggestion is generated based on the at least one score (Block 270).

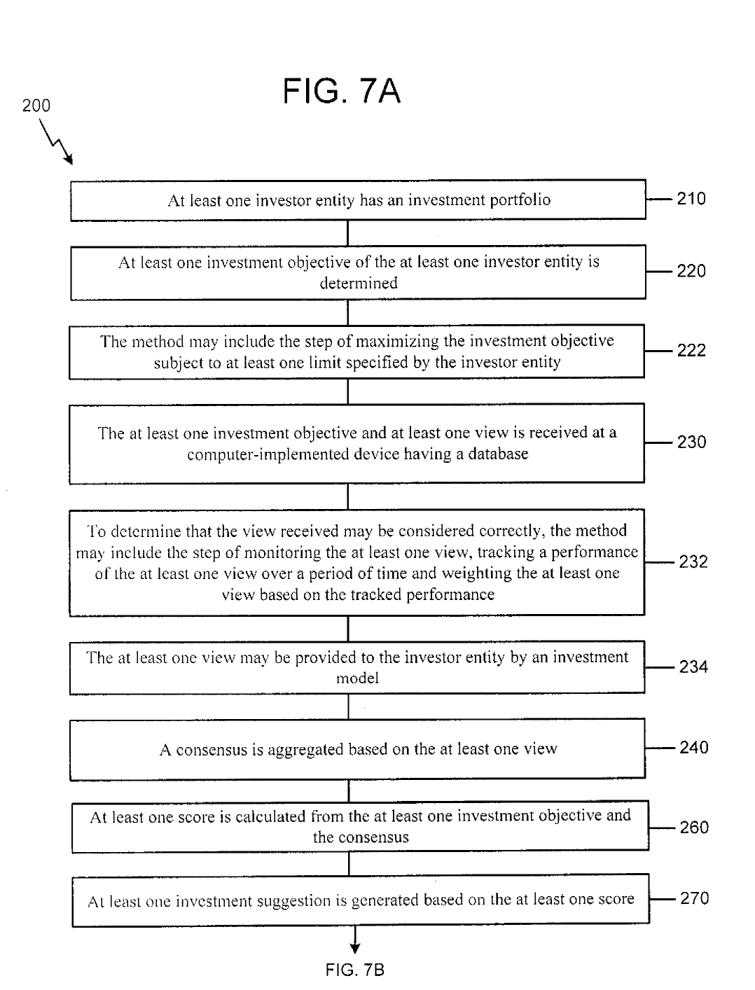

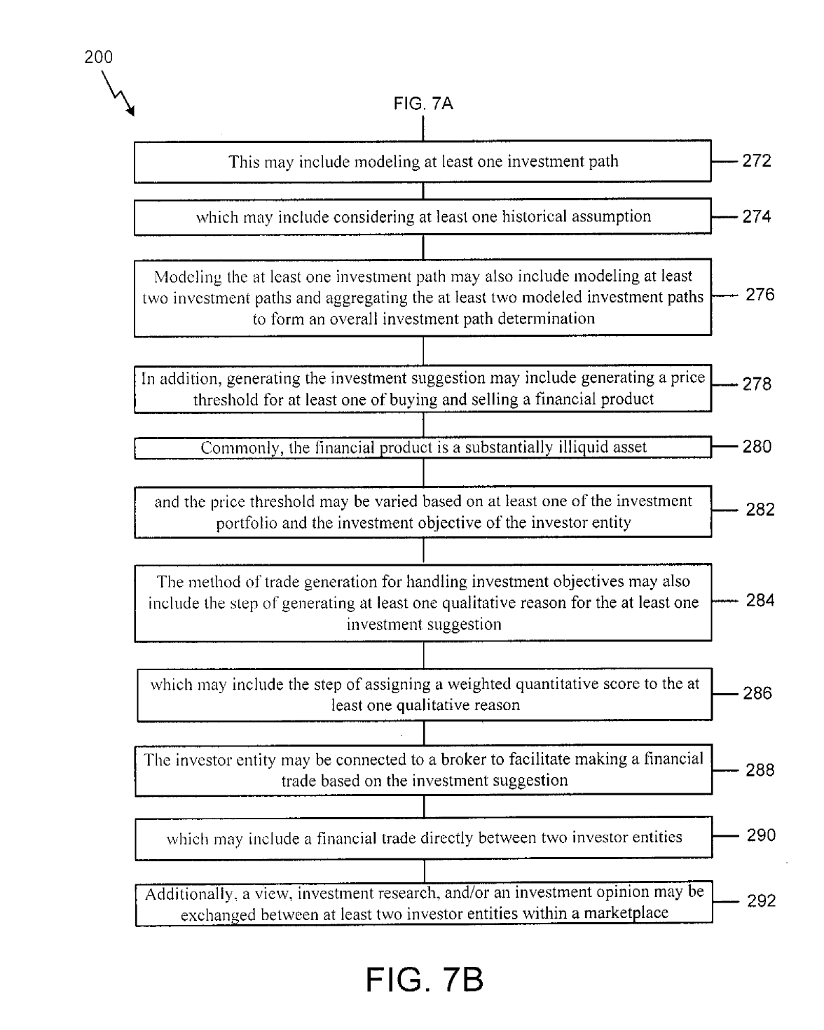

FIGS. 7A-7B are a flowchart 200 illustrating a method of trade generation to achieve investment objectives, in accordance with the third exemplary embodiment of the present disclosure. It should he noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure. It is further noted that the method may be completed with the omission of any of the process descriptions or blocks in the flow charts, any combination of which is considered within the scope of the present disclosure.

As is shown by block 210, at least one investor entity has an investment portfolio. At least one investment objective of the at least one investor entity is determined (Block 220). The method may include the step of maximizing the investment objective subject to at least one limit specified by the investor entity (Block 222). The at least one investment objective and at least one view is received at a computer-implemented device having a database (Block 230). To to determine that the view received may be considered correctly, the method may include the step of monitoring the at least one view, tracking a performance of the at least one view over a period of time and weighting the at least one view based on the tracked performance (Block 232). The at least one view may be provided to the investor entity by an investment model (Block 234). A consensus is aggregated based on the at least one view (Block 240). At least one score is calculated from the at least one investment objective and the consensus (Block 260).

At least one investment suggestion is generated based on the at least one score (Block 270). This may include modeling at least one investment path (Block 272), which may include considering at least one historical assumption (274). Modeling the at least one investment path may also include modeling at least two investment paths and aggregating the at least two modeled investment paths to form an overall investment path determination (Block 276). In addition, generating the investment suggestion may include generating a price threshold for at least one of buying and selling a financial product (Block 278). Commonly, the financial product is a substantially illiquid asset (Block 280) and the price threshold may be varied based on at least one of the investment portfolio and the investment objective of the investor entity (Block 282).

The method of trade generation to achieve investment objectives may also include the step of generating at least one qualitative reason for the at least one investment suggestion (Block 284), which may include the step of assigning a weighted quantitative score to the at least one qualitative reason (Block 286). The investor entity may be connected to a broker to facilitate making a financial trade based on the investment suggestion (Block 288), which may include a financial trade directly between two investor entities (Block 290). Additionally, a view, investment research, and/or an investment opinion may be exchanged between at least two to investor entities within a marketplace (Block 292).

The method of trade generation to achieve investment objectives may include any number of additional steps and/or processes. For example, maximizing the investment objective subject to at least one limit specified by the investor entity (block 222) may be accomplished by a variety of methods, including maximizing a single objective within the portfolio, or maximizing all of the investment objectives of a portfolio. For example, the expected return of the portfolio may be maximized within a given period of time, while ensuring that the likelihood of the portfolio losing more than a certain percentage of value is kept below a certain probability.

Any number of additional steps or processes, or an alteration of an existing step of process may also be included. For example, the investment objective may be adjusted to analyze a risk associated with the portfolio. The method may also include receiving and storing a plurality of views from a plurality of investment advice giving user. The at least one received view from the plurality of views may be selected for aggregating an overall view. The investor entity may inspect any of the plurality of views, which may be displayed on a display device. Additionally, the aggregated overall view and the investment suggestion may also be graphically displayed on a display device.

The investor entity may also choose to select an alternate view to follow, such as a view based on a quantity of historical market data. This view may be derived through analysis of data collected by the system over a period of time. Forecasts derived from historical data might typically be used to Fill in any gaps where for any given financial instrument or market factor, views have not been expressed by any users of the system, or have been expressed incompletely. In addition, when generating the investment suggestion, an investment path having at least one set of time series of probability distributions for the at least one investment objective may also be generated. Within the method or trade generation to achieve investment objectives, a simulation of future market values and cash flows may be used to calculate a score corresponding to the at least one investment objective. The simulation may produce a variety data concerning various aspects of the investment objective, and the likelihood of achieving the investment objective. For example, the simulation may output a graph of how the probability of achieving various portfolio values, such as the total portfolio P&L, varies with time. The investment objective might then relate to the expected portfolio value 12 months from now. The simulation may be used in response to an investor entity request and/or a predetermined schedule.

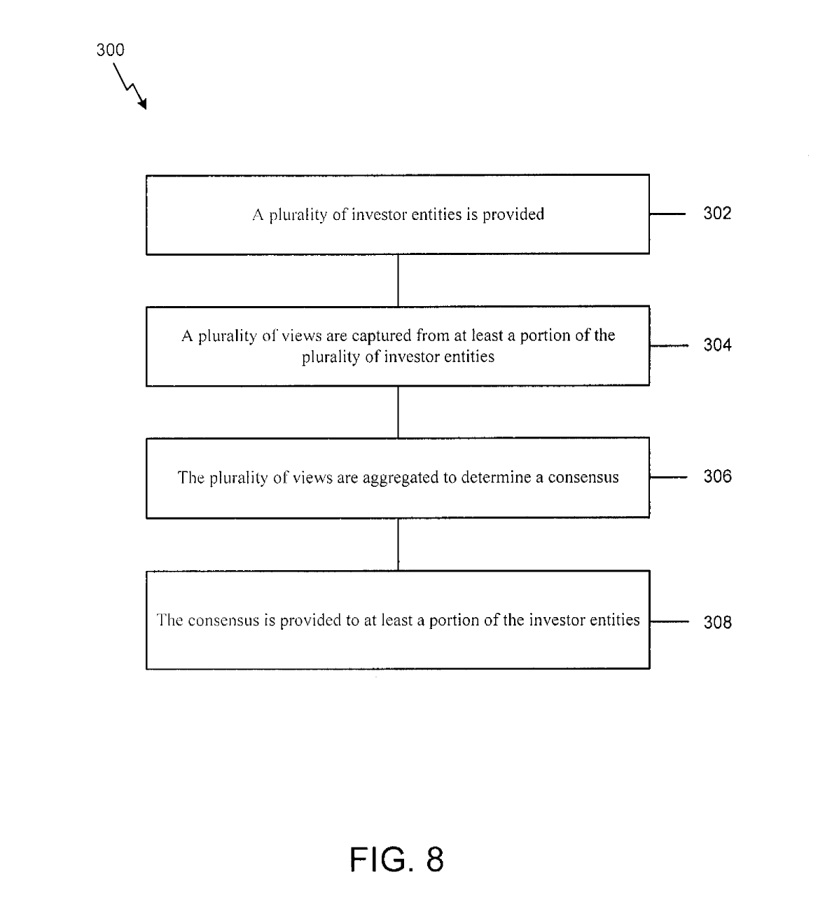

FIG. 8 is a flowchart 300 illustrating a method providing a consensus to a plurality of investors, in accordance with a fourth first exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure. It is noted that the method may be carried out on any type of computerized or electronic device, as is taught in other embodiments of this disclosure.

At block 302, a plurality of investor entities is provided. A plurality of views are captured from at least a portion of the plurality of investor entities (block 304). The plurality of views are aggregated to determine a consensus (block 306). The consensus is provided to at least a portion of the investor entities (block 308).

It should be emphasized that the above-described embodiments of the present disclosure, particularly, any “preferred” embodiments, are merely possible examples of implementations, merely set forth for a clear understanding of principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

What is claimed is:

1. A system for trade generation to achieve investment objectives, the system comprising:
a first user having a portfolio and at least one investment objective;
a computer-implemented device having a database, the database receiving the at least one investment objective and at least one view;
an aggregation system in communication with the database, wherein the aggregation system aggregates a consensus based on the at least one view;
a scoring system in communication with the database, wherein the scoring system calculates at least one score from the at least one investment objective and the consensus; and
an investment suggestion generator positioned to output at least one investment suggestion based on the at least one score.

2. The system for trade generation to achieve investment objectives of claim 1, wherein the at least one view is received from a second user, wherein the at least one view is capable of influencing at least a portion of the at least one score.

3. The system for trade generation to achieve investment objectives of claim 1, wherein the at least one view is weighted.

4. The system for trade generation to achieve investment objectives of claim 1, wherein scoring system further comprises a modeling element modeling at least one investment path to achieve the at least one investment objective.

5. The system for trade generation to achieve investment objectives of claim 1, further comprising a constraint input system facilitating the at least one first user to specify at least one investment constraint

6. A method of trade generation to achieve investment objectives, the method comprising the steps of:
providing at least one investor entity having an investment portfolio;
determining at least one investment objective of the at least one investor entity;
receiving the at least one investment objective and at least one view at a computer-implemented device having a database;
aggregating a consensus based on the at least one view;
calculating at least one score from the at least one investment objective and the consensus; and
generating at least one investment suggestion based on the at least one score.

7. The method of trade generation to achieve investment objectives of claim 6, wherein the step of generating at least one investment suggestion further comprises modeling at least one investment path.

8. The method of trade generation to achieve investment objectives of claim 7, wherein modeling the at least one investment path further comprises the step of considering at least one historical assumption.

9. The method of trade generation to achieve investment objectives of claim 7, wherein modeling the at least one investment path further comprises modeling at least two investment paths and aggregating the at least two modeled investment paths to form an overall investment path determination.

10. The method of trade generation to achieve investment objectives of claim 6, further comprising the step of maximizing the investment objective subject to at least one limit specified by the investor entity.

11. The method of trade generation to achieve investment objectives of claim 6, further comprising the steps of:
monitoring the at least one view;
tracking a performance of the at least one view over a period of time; and
weighting the at least one view based on the tracked performance.

12. The method of trade generation to achieve investment objectives of claim 6, wherein the at least one view is provided to the investor entity by an investment model.

13. The method of trade generation to achieve investment objectives of claim 6, further comprising the step of generating at least one qualitative reason for the at least one investment suggestion.

14. The method of trade generation to achieve investment objectives of claim 13, further comprising the step of assigning a weighted quantitative score to the at least one qualitative reason.

15. The method of trade generation to achieve investment objectives of claim 13, further comprising the step of connecting the at least one investor entity to a broker to facilitate making a financial trade based on the investment suggestion.

16. The method of trade generation to achieve investment objectives of claim 15, wherein the financial trade occurs between at least two investor entities.

17. The method of trade generation to achieve investment objectives of claim 6, further comprising the step of exchanging at least one of view, investment research, and an investment opinion between at least two investor entities.

18. The method of trade generation to achieve investment objectives of claim 6, wherein the step of generating at least one investment suggestion based on the at least one score further comprises generating a price threshold for at least one of buying and selling an investment.

19. The method of trade generation to achieve investment objectives of claim 18, further comprising the step of varying the generated price threshold based on at least one of the investment portfolio and the investment objective of the investor entity.

20. The method of trade generation to achieve investment objectives of claim 18, wherein the financial product is a substantially illiquid asset.

21. A method of providing a consensus to a plurality of investors, the method to comprising the steps of:
providing a plurality of investor entities;
capturing a plurality of views from at least a portion of the plurality of investor entities;
aggregating the plurality of views to determine a consensus; and
providing the consensus to at least a portion of the investor entities.
